(19) United States
(12) Patent Application Publication
(10) Pub. No.: US 2022/0340038 A1
(43) Pub. Date: Oct. 27, 2022

(54) CHARGING MANAGEMENT METHODS AND SYSTEMS FOR ELECTRIC VEHICLE CHARGING STATIONS

(71) Applicant: Noodoe Corporation, Taipei City (TW)

(72) Inventors: Yi-An HOU, Taipei City (TW); Chun-Hung KUNG, Taipei City (TW)

(21) Appl. No.: 17/676,309

(22) Filed: Feb. 21, 2022

(30) Foreign Application Priority Data
Apr. 23, 2021 (TW) 110114787

(51) Int. Cl. B60L 53/67; B60L 53/62; H02J 7/00; G06Q 50/06

(52) U.S. Cl. CPC B60L 53/67; B60L 53/62; H02J 7/0048; H02J 7/00032; G06Q 50/06

(57) ABSTRACT

Charging management methods and systems for electric vehicle charging stations in a charging field are provided. First charging station uses a power parameter which is an upper power limit value of first charging station to perform a charging operation for an electric vehicle. When remaining power of a charging field is lower than the upper power limit value of a second charging station, the server performs a load adjustment simulation operation. In load adjustment simulation operation, the server communicates with first charging station through a network to instruct first electric vehicle charging station to adjust the power parameter from the upper power limit value to a specific value during the charging operation. When the power output from first charging station to the electric vehicle during the charging operation is not adjusted to the specific value, the server sets second charging station to be in a service suspended state.

### BACKGROUND OF THE INVENTION

### Field of the Invention

The disclosure relates generally to charging management methods and systems for electric vehicles, and, more particularly to methods and systems that can perform a load adjustment simulation for charging operations in advance to facilitate the execution of subsequent load adjustment operations.

### Description of the Related Art

Recently, with the rising awareness of environmental protection and electric vehicle technology advances, the development of electric vehicles powered by electrical energy to replace traditional vehicles powered by fossil fuels has gradually become an important goal in the automotive field, thus making electric vehicles become more and more popular. In order to increase the range and willingness to use electric vehicles, many countries or cities have begun to set up charging stations in public places to provide electricity to electric vehicles, and have also begun to plan the deployment of a large number of charging stations in urban areas or scenic areas, so as to make the charging of electric vehicles more convenient.

Generally, the power equipment in the most field has already been constructed. To update the power equipment, such as the capacity of the electric panel, it is expensive and the construction time is long. Often, the number of charging stations that can be installed in a single charging field is limited by the existing maximum load capacity of the field. Therefore, in the case of limited charging stations, the drivers of electric vehicles may have to wait since the charging station may be in use, or need to find other nearby charging stations for charging operations, which causes inconvenience in use, and drives the willingness to adopt electric vehicles.

Therefore, under the premise of not updating the power equipment, some charging fields can introduce load adjustment operations to increase the number of charging stations that can be installed in the field. In the load adjustment operation, by reducing the power output of individual charging stations, more electric vehicles can be charged in the charging field at the same time. However, due to communication limitations between the charging station and the electric vehicle, field power trips often occur when the incoming vehicle is charging during the load operation, resulting in the suspension or interruption of the electric vehicle in the charging operation.

On the other hand, load adjustment tasks are usually performed when a request is generated in the charging field, such as when a new electric car wants to be charged. However, due to differences in the design and specifications of electric vehicles of different brands or models, the results of communication between charging stations and electric vehicles often reveal that some electric vehicles do not accept the instructions of the charging station to participate in the load adjustment operation. Therefore, if some electric vehicles refuse to participate in the load adjustment operation, it will lead to a situation where the new electric vehicles cannot be charged.

### BRIEF SUMMARY OF THE INVENTION

In a charging management method for electric vehicle charging stations for use in a charging field with a power limit, wherein the charging field comprises a first charging station and a second charging station which are respectively connected with a server via a network, a charging operation is performed for an electric vehicle using a power parameter by the first charging station, wherein the power parameter is an upper power limit value of the first charging station. A remaining power of the charging field is calculated according to the power limit of the charging field and the upper power limit value of the first charging station. It is determined whether the remaining power of the charging field is lower than the upper power limit value of the second charging station. When the remaining power of the charging field is lower than the upper power limit value of the second charging station, a load adjustment simulation operation is performed by the server. In the load adjustment simulation operation, the server communicates with the first charging station through the network to instruct the first charging station to adjust the power parameter from the upper power limit value to a specific value during the charging operation, monitors the power output from the first charging station to the electric vehicle during the charging operation, determines whether the power output from the first charging station to the electric vehicle during the charging operation is adjusted to the specific value, and sets the second charging station to be in a service suspended state when the power output from the first charging station to the electric vehicle during the charging operation is not adjusted to the specific value.

An embodiment of a charging management system for electric vehicle charging stations for use in a charging field with a power limit comprises a first charging station, a second charging station, and a server. The first charging station performs a charging operation for an electric vehicle using a power parameter, wherein the power parameter is an upper power limit value of the first charging station. The server respectively connects with the first charging station and the second charging station via a network, and calculates a remaining power of the charging field according to the power limit of the charging field and the upper power limit value of the first charging station. The server determines whether the remaining power of the charging field is lower than the upper power limit value of the second charging station, and performs a load adjustment simulation operation when the remaining power of the charging field is lower than the upper power limit value of the second charging station. In the load adjustment simulation operation, the server communicates with the first charging station through the network to instruct the first charging station to adjust the power parameter from the upper power limit value to a specific value during the charging operation, monitors the power output from the first charging station to the electric vehicle during the charging operation, determines whether the power output from the first charging station to the electric vehicle during the charging operation is adjusted to the specific value, and sets the second charging station to be in a service suspended state when the power output from the first charging station to the electric vehicle during the charging operation is not adjusted to the specific value.

In some embodiments, in the load adjustment simulation operation, the server further indicates a state of the second charging station as the service suspended state in a user query interface when the power output from the first charging station to the electric vehicle during the charging operation is not adjusted to the specific value.

In some embodiments, in the load adjustment simulation operation, the server further communicates with the first charging station through the network to instruct the first charging station to adjust the power parameter from the specific value back to the upper power limit value of the first charging station during the charging operation when the power output from the first charging station to the electric vehicle during the charging operation is adjusted to the specific value.

In some embodiments, the specific value id a lower power limit value of the first charging station.

In some embodiments, the server further sends a confirmation request to a specific mobile device corresponding to the electric vehicle via the network, receives a confirmation signal in response to the confirmation request from the specific mobile device via the network, and executes the load adjustment simulation operation in response to the confirmation signal.

Charging management methods for electric vehicle charging stations may take the form of a program code embodied in a tangible media. When the program code is loaded into and executed by a machine, the machine becomes an apparatus for practicing the disclosed method.

### BRIEF DESCRIPTION OF THE DRAWINGS

The invention will become more fully understood by referring to the following detailed description with reference to the accompanying drawings, wherein:

FIG. 1 is a schematic diagram illustrating an embodiment of a charging management system for electric vehicle charging stations of the invention;

FIG. 2 is a schematic diagram illustrating an embodiment of an electric vehicle charging station of the invention;

FIG. 3 is a schematic diagram illustrating an embodiment of a server of the invention;

FIG. 4 is a flowchart of an embodiment of a charging management method for electric vehicle charging stations of the invention;

FIG. 5 is a flowchart of an embodiment of a load adjustment simulation operation of the invention;

FIG. 6 is a flowchart of another embodiment of a load adjustment simulation operation of the invention; and

FIG. 7 is a flowchart of another embodiment of a charging management method for electric vehicle charging stations of the invention.

### DETAILED DESCRIPTION OF THE INVENTION

The following description is of the best-contemplated mode of carrying out the invention. This description is made for the purpose of illustrating the general principles of the invention and should not be taken in a limiting sense. It should be understood that the embodiments may be realized in software, hardware, firmware, or any combination thereof.

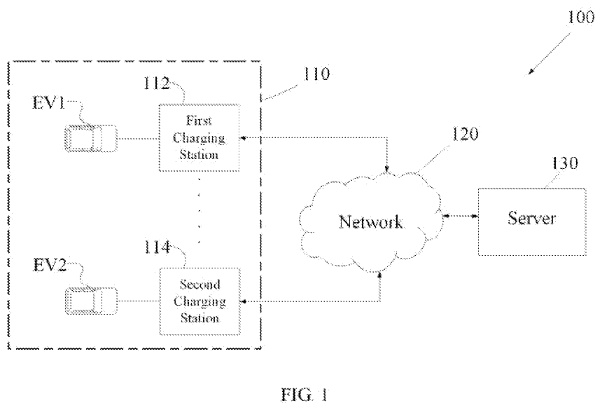

FIG. 1 is a schematic diagram illustrating an embodiment of a charging management system for electric vehicle charging stations of the invention. The charging management system for electric vehicle charging stations 100 can be used in a charging filed 110 with a plurality of electric vehicle charging stations. It is noted that, the charging filed 110 has a power limitation. As shown in FIG. 1, the charging management system for electric vehicle charging stations 100 comprises at least a first charging station 112, a second charging station 114, and a server 130 respectively connected with the first charging station 112 and the second charging station 114 via a network 120. The respective charging stations can provide electric vehicles (EV1, EV2) for charging operations. In some embodiments, the network 120 may be a wired network, a telecommunication network, and a wireless network, such as a Wi-Fi network. The server 130 can respectively receive various data from the first charging station 112 and the second charging station 114, and transmit related signals to the first charging station 112 and the second charging station 114. The first charging station 112 and the second charging station 114 can perform related operations according to the signals received from the server 130. For example, when the electric vehicle EV1 is coupled to the first charging station 112 through a charging gun of the first charging station 112 for a charging operation, the first charging station 112 can continuously transmit charging information corresponding the charging operation of the electric vehicle EV1 via the network 120, and the server 130 can receive the charging information of the corresponding charging operation from the first charging station 112 via the network 120. Similarly, when the electric vehicle EV2 is coupled to the second charging station 114 through a charging gun of the second charging station 114 to perform a charging operation, the second charging station 114 can continuously transmit the charging information corresponding the charging operation of the electric vehicle EV2 via the network 120, and the server 130 can receive the charging information of the corresponding charging operation from the second charging station 114 via the network 120. In some embodiments, the charging information may include at least a charging start time, a charging period, an output power, and/or related information indicating whether a load adjustment operation is being performed. The server 130 can know the usage status of the corresponding electric vehicle charging station according to the charging information.

It is noted that the user can connect the electric vehicle EV1 and the first charging station 112 to each other, such as inserting a charging gun into the charging port of the electric vehicle to send a charging request corresponding to the first charging station 112 to use the first charging station 112. The first charging station 112 performs a charging operation for the electric vehicle EV1. Similarly, the user can connect the electric vehicle EV2 and the second charging station 114 to each other, such as inserting a charging gun into the charging port of the electric vehicle to send a charging request corresponding to the second charging station 114 to use the second charging station 114. It is understood that, in some embodiments, the server 130 may directly or indirectly receive a charging request from a mobile device (not shown in FIG. 1) of the owner of the electric vehicle EV1, and generate a charging authorization command based on the charging request and transmit it to the first charging station 112 via the network 120, so that the first charging station 112 outputs power to the electric vehicle EV1, such as an electric scooter or an electric car, which is electrically connected to it, or prohibits the first charging station 112 from outputting power to the electric vehicle EV1. It is reminded that, in some embodiments, the charging request may be accompanied by an identity authentication and/or a payment mechanism, and the charging authorization command will only be generated after the identity authentication and/or payment mechanism is completed. In some embodiments, the user of the electric vehicle EV1 can use his/her mobile device to download and install an application to generate a charging request through the user interface of the application. In some embodiments, the user can scan a Quick Response Code (QR code) on the first charging station 112 through the scanning function of the application to generate the above-mentioned charging request, thereby starting a charging operation. In some embodiments, the user can select a specific charging station through the application and execute an activation function to generate the above-mentioned charging request, thereby starting a charging operation. It is understood that, in some embodiments, the owner of the electric vehicle EV1 can use an RFID card to approach an induction area (not shown in FIG. 1) on the first charging station 112 to generate a corresponding charging request, and sent it to the server 130 via the network 120. It is reminded that, in some embodiments, each user can have an RFID card.

It is noted that, the device corresponding to the owner of the electric vehicle can be any electronic device capable of Internet access, such as mobile devices, such as mobile phones, smart phones, personal digital assistants, global positioning systems, and notebook computers. In some embodiments, the mobile device can receive status information and notifications of the corresponding charging operation from the cloud management server 130 via the network 120. In some embodiments, the status information and notification may include notifying that the electric vehicle has stopped charging, notifying that the vehicle needed to be moved, and/or notifying that the charging gun of the electric vehicle charging device has been disconnected from the electric vehicle, and so on.

As mentioned above, the charging field 110 has a power limit. The server 130 can perform a load adjustment operation for the electric vehicle charging stations in the charging field 110 according to at least one energy management scheme. Specifically, the server 130 can generate an instruction and send the instruction to the respective charging station (112, 114) via the network 120 to control the charging station to output power for charging with a specified power parameter, such as a specified amperage, during a specific period of time to the electric vehicle connected to the station, or to prohibit the charging station from outputting power to the electric vehicle. Additionally, the server 130 can also perform a load adjustment simulation operation of the present invention for the electric vehicle charging stations in the charging field 110. The details of the load adjustment simulation operation will be described later.

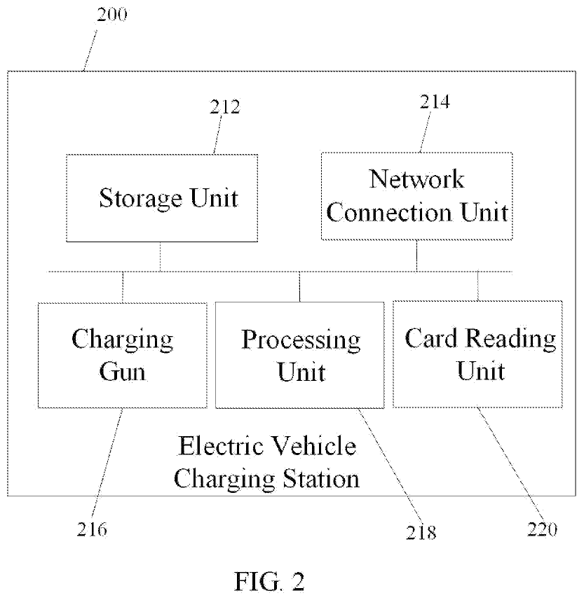

FIG. 2 is a schematic diagram illustrating an embodiment of an electric vehicle charging station of the invention. The electric vehicle charging station 200 shown in FIG. 2 can be applied to the first charging station 112 and the second charging station114 in FIG. 1, which has processing and computing capabilities to perform charging management operations for the electric vehicle charging station. The electric vehicle charging station 200 has a network connection capability to receive, download or update various parameters and information required for charging management calculations.

The electric vehicle charging station 200 at least comprises a storage unit 212, a network connection unit 214, a charging gun 216, a processing unit 218, and a card reading unit 220. The storage unit 212 may be a memory or a database for storing and recording related data. The data may be related information such as charging station ID of the electric vehicle charging station and charging requests. It should be noted that the aforementioned information is only example, and the invention is not limited thereto. The network connection unit 214 can use a network, such as a wired network, a telecommunications network, and a wireless network, such as a Wi-Fi network, to receive, download, or update various parameters and information required for charging management operations. The charging gun 216 may include one or more charging connectors that meet the same charging interface specification or meet different charging interface specifications, and are electrically connected to the corresponding electric vehicle. The processing unit 218 can control the operations of related software and hardware in the electric vehicle charging station 200, and cooperate with the server 130 to execute the charging management method for electric vehicle charging stations of the invention. Related details will be described later. It is noted that, in some embodiments, the processing unit 218 may be a general-purpose controller, a Micro-Control Unit, MCU, or a Digital Signal Processor, DSP, etc., to provide functions of data analysis, processing and calculation, but the present invention is not limited to this. In one embodiment, the processing unit 218 may use the network connection unit 214 to transmit the power state of the corresponding electric vehicle through a network for a cloud management server, such as the cloud server 130, for subsequent charging management. In another embodiment, the processing unit 218 can obtain the power parameter of a charging operation from the server 130, determine the output power according to the power parameter received from the server 130, and output the power to at least one electric vehicle through the charging gun 216 to perform the charging operation. The card reading unit 220 may be an RFID reading unit for sensing information of a physical card, such as RFID card. The information sensed from the RFID card may be a card identification code of the physical card.

It is understood that, the electric vehicle charging station 200 has an upper power limit value and a lower power limit value. Specifically, the electric vehicle charging station 200 can use the upper power limit value as the power parameter at the highest to output power to the electric vehicle during a charging operation. On the other hand, the electric vehicle charging station 200 needs to use the lower power limit value as the power parameter at least to output power to the electric vehicle during a charging operation. It must be noted that, charging stations of different brands and models may have different upper power limit values for output power and lower power limit values for output power. The present invention is not limited to any value, and the value may be different for different charging stations.

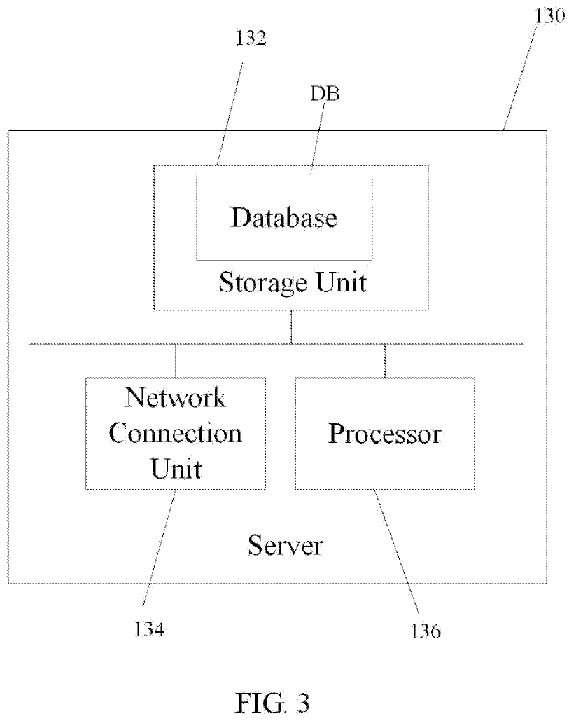

FIG. 3 is a schematic diagram illustrating an embodiment of a server of the invention. As shown in FIG. 3, the server 130 of the invention can be any processor-based electronic device, which comprises at least a storage unit 132, a network connection unit 134, and a processor 136. It is noted that, the server 130 can receive various data corresponding to a plurality of electric vehicle charging stations in a charging field. The server 130 can directly or indirectly receive a charging request from a mobile device, and after completing actions such as identity confirmation in response to the charging request, generate a charging authorization command and transmit it to the corresponding electric vehicle charging station via the network. In response to the charging authorization command, the electric vehicle charging station is allowed to output power to an electric vehicle (for example, an electric motorcycle or an electric vehicle, etc.) that is electrically connected to it, or prohibit the electric vehicle charging station from outputting power to the electric vehicle.

The storage unit 132 may be a memory comprising a database DB, which can store and record related data, such as various data of the electric vehicle charging stations. In addition, in some embodiments, the database DB may also record different users and corresponding user identification codes. Through the network connection unit 134, the server 130 can be coupled to and communicates with the electric vehicle charging stations (112, 114) via the network 120, such as a wired network, a telecommunications network, and a wireless network, such as a Wi-Fi network, and transmits related data/signals/commands to different electric vehicle charging stations via the network 120 to control whether the electric vehicle charging stations output power, and specify power parameters for outputting power to electric vehicles. The processor 136 can control the operations of related software and hardware in the server 130, and execute the charging management methods for electric vehicle charging stations of the invention. The relevant details will be described later. It is understood that, in some embodiments, the processor 136 may be a general-purpose controller, a Micro-Control Unit, MCU, or a Digital Signal Processor, DSP, etc., to provide data analysis, processing, and calculation functions.

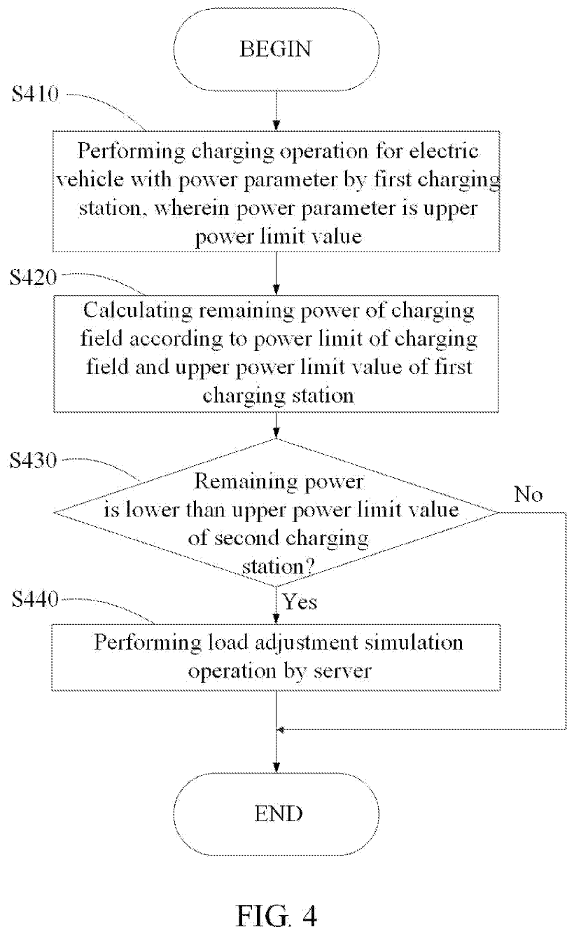

FIG. 4 is a flowchart of an embodiment of a charging management method for electric vehicle charging stations of the invention. The charging management method for electric vehicle charging stations of the invention is applicable to a charging field with at least a first charging station and a second charging station, and the charging field has a power limit. The respective electric vehicle charging station in the charging field can be electrically coupled with a remote server via a network.

In step S410, a charging operation with a power parameter is performed for an electric vehicle by the first charging station. As described, the first charging station has an upper power limit value and a lower power limit value. In some embodiments, the power parameter is the upper power limit value of the first charging station. In some embodiments, the power parameter can also be any value higher than the lower power limit value. In addition, it should be noted that in some embodiments, the user can connect the electric vehicle to the first charging station, such as inserting a charging gun into the charging port of the electric vehicle, to send out a charging request corresponding to the first charging station, thus to use the first charging station to charge the electric vehicle. In some embodiments, the server may directly or indirectly receive a charging request from a mobile device of the owner of the electric vehicle EV1, generate a charging authorization command according to the charging request, and transmit it to the first charging station via the network, so that the first charging station outputs power to the electric vehicle connected to it for charging operations. In some embodiments, the user of the electric vehicle can download and install an application program by using his mobile device to generate a charging request through the user interface of the application program to perform the charging operation. In some embodiments, the user can scan a QR code on the first charging station through the scanning function of the application program to generate the above-mentioned charging request to perform the charging operation. In some embodiments, the user can select a specific charging station through the application program and execute an activation function to generate the above-mentioned charging request to perform the charging operation. In some embodiments, the owner of the electric vehicle can use an RFID card to approach an induction area on the first charging station to generate a corresponding charging request to perform the charging operation.

Then, in step S420, a remaining power of the charging field is calculated according to the power limit of the charging field and the upper power limit value of the first charging station. In step S430, the server determines whether the remaining power of the charging field is lower than the upper power limit value of the second charging station. Similarly, the second charging station also has an upper power limit value and a lower power limit value. It is reminded that the upper power limit value and the lower power limit value of the first charging station and the second charging station may be different. When the remaining power is not lower than the upper power limit value of the second charging station (No in step S430), the process ends. When the remaining power is lower than the upper power limit value of the second charging station (Yes in step S430), in step S440, the server executes a load adjustment simulation operation. It is reminded that the main purpose of the load adjustment simulation operation is to test whether the electric vehicle connected to the first electric vehicle charging station will accept the instruction to perform the load adjustment operation. The load adjustment simulation operation will be described later.

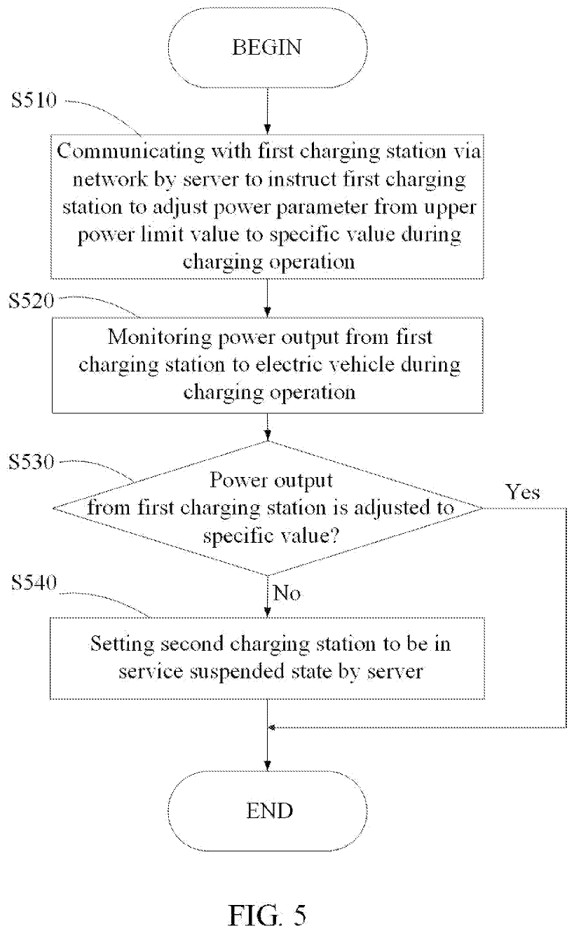

FIG. 5 is a flowchart of an embodiment of a load adjustment simulation operation of the invention. In the load adjustment simulation operation, in step S510, the server communicates with the first charging station through the network to instruct the first charging station to adjust the power parameter from the upper power limit value to a specific value during the charging operation, wherein the specific value is lower than the upper power limit value. It is reminded that, as mentioned above, when the original power parameter of the charging operation is any value higher than the lower power limit value, the specific value must also be lower than this value. It is worth noting that, in some embodiments, the specific value is the lower power limit value of the first charging station. Then, in step S520, the power output from the first charging station to the electric vehicle during the charging operation is monitored, and in step S530, it is determined whether the power output from the first charging station to the electric vehicle during the charging operation has been adjusted to the specific value. When the power output by the first charging station to the electric vehicle during the charging operation has been adjusted to the specific value (Yes in step S530), the process ends. When the power output from the first charging station to the electric vehicle during the charging operation is not adjusted to the specific value (No in step S530), in step S540, the server causes the second charging station in the charging field to be in a service suspended state. It is reminded that when the power output from the first charging station to the electric vehicle during the charging operation is not adjusted to the specific value, the first charging station and the corresponding charging operation will be marked to exclude the load adjustment operations in the future. Please note that when the charging operation is complete, the mark of the first charging station can be removed.

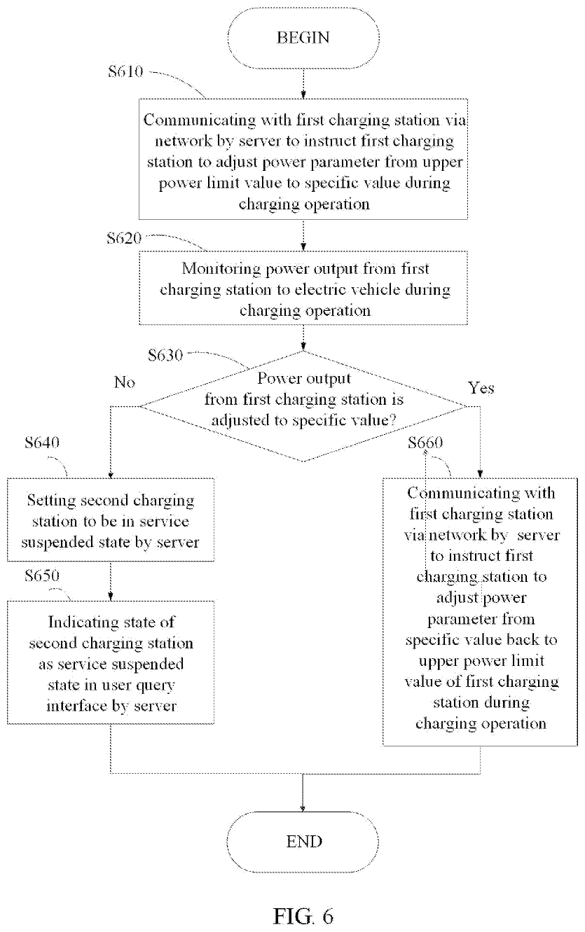

FIG. 6 is a flowchart of another embodiment of a load adjustment simulation operation of the invention. In the load adjustment simulation operation, in step S610, the server communicates with the first charging station through the network to instruct the first charging station to adjust the power parameter from the upper power limit value to a specific value during the charging operation, wherein the specific value is lower than the upper power limit value. Similarly, when the original power parameter of the charging operation is any value higher than the lower power limit value, the specific value must also be lower than this value. It is worth noting that, in some embodiments, the specific value is the lower power limit value of the first charging station. Then, in step S620, the power output from the first charging station to the electric vehicle during the charging operation is monitored, and in step S630, it is determined whether the power output from the first charging station to the electric vehicle during the charging operation has been adjusted to the specific value. When the power output from the first charging station to the electric vehicle during the charging operation is not adjusted to the specific value (No in step S630), in step S640, the server causes the second charging station in the charging field to be in a service suspended state, and in step S650, the server marks the available status of the second charging station of the charging field as a service suspended state in a user query interface, such as a query website or application (APP) for electric vehicle charging stations. It is reminded that when the power output from the first charging station to the electric vehicle during the charging operation is not adjusted to the specific value, the first charging station and the corresponding charging operation will be marked to exclude the load adjustment operations in the future. Please note that when the charging operation is complete, the mark of the first charging station can be removed. When the power output by the first charging station to the electric vehicle during the charging operation has been adjusted to the specific value (Yes in step S630), in step S660, the server communicates with the first charging station through the network to instruct the first charging station to adjust the power parameter from the specific value back to the upper power limit value during the charging operation. It is noted that when the power parameter of the charging operation is a value higher than the lower power limit value, the power parameter will be adjusted back to the original value from the specific value in step S660.

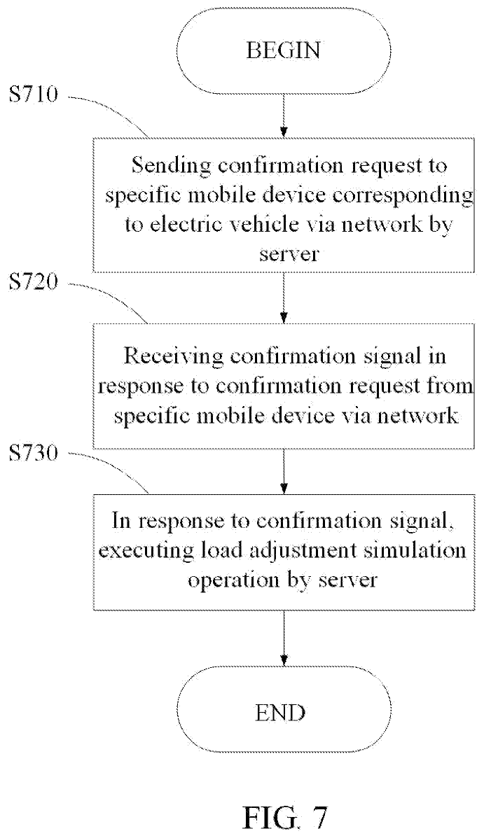

FIG. 7 is a flowchart of another embodiment of a charging management method for electric vehicle charging stations of the invention. In this embodiment, the server may first seek the consent of the electric vehicle owner currently charging at the first charging station before performing the load adjustment simulation operation.

First, in step S710, the server transmits a confirmation request to a specific mobile device corresponding to the electric vehicle via the network. It is noted that, in some embodiments, the confirmation request may be used to notify that a load adjustment simulation operation will be performed to the charging operation corresponding to the electric vehicle, and require the user to agree and confirm. In step S720, the server receives a confirmation signal corresponding to the confirmation request from the specific mobile device via the network. In some embodiments, the confirmation request received by the specific mobile device may include a confirmation button. When the confirmation button is pressed, the specific mobile device can send a confirmation signal to the server. It is reminded that the confirmation request received by a specific mobile device can also include a reject button. After the rejection button is pressed, the specific mobile device can send a rejection signal to the server. In other words, the specific mobile device refuses to perform the load adjustment simulation operation. In response to the confirmation signal, in step S730, the server performs the load adjustment simulation operation.

Since the electric vehicles manufactured by various car manufacturers do not necessarily meet the charging standard specifications, there may be situations in which certain electric vehicles do not reduce the power output according to the instructions of the server during load adjustment operations. Therefore, the charging management methods and systems for electric vehicle charging stations of the present invention can perform early simulation detection for the charging operation in progress, so as to facilitate the execution of the subsequent load adjustment operation, thereby reducing the problems that may occur during the actual execution of the load adjustment operation. Additionally, users can know the availability of electric vehicle charging stations in the charging field, and avoid the situation where they cannot be charged when they arrive at the charging field.

Charging management methods for electric vehicle charging stations, may take the form of a program code (i.e., executable instructions) embodied in tangible media, such as floppy diskettes, CD-ROMS, hard drives, or any other machine-readable storage medium, wherein, when the program code is loaded into and executed by a machine, such as a computer, the machine thereby becomes an apparatus for executing the methods. The methods may also be embodied in the form of a program code transmitted over some transmission medium, such as electrical wiring or cabling, through fiber optics, or via any other form of transmission, wherein, when the program code is received and loaded into and executed by a machine, such as a computer, the machine becomes an apparatus for executing the disclosed methods. When implemented on a general-purpose processor, the program code combines with the processor to provide a unique apparatus that operates analogously to application specific logic circuits.

While the invention has been described by way of example and in terms of preferred embodiment, it is to be understood that the invention is not limited thereto. Those who are skilled in this technology can still make various alterations and modifications without departing from the scope and spirit of this invention. Therefore, the scope of the present invention shall be defined and protected by the following claims and their equivalent.

What is claimed is:

1. A charging management method for electric vehicle charging stations for use in a charging field with a power limit, wherein the charging field comprises a first charging station and a second charging station which are respectively connected with a server via a network, comprising:
performing a charging operation for an electric vehicle using a power parameter by the first charging station, wherein the power parameter is an upper power limit value of the first charging station;
calculating a remaining power of the charging field according to the power limit of the charging field and the upper power limit value of the first charging station;
determining whether the remaining power of the charging field is lower than the upper power limit value of the second charging station; and
performing a load adjustment simulation operation by the server when the remaining power of the charging field is lower than the upper power limit value of the second charging station, wherein the load adjustment simulation operation comprises the steps of:
communicating with the first charging station through the network by the server to instruct the first charging station to adjust the power parameter from the upper power limit value to a specific value during the charging operation;
monitoring the power output from the first charging station to the electric vehicle during the charging operation;
determining whether the power output from the first charging station to the electric vehicle during the charging operation is adjusted to the specific value; and
setting the second charging station to be in a service suspended state by the server when the power output from the first charging station to the electric vehicle during the charging operation is not adjusted to the specific value.

2. The method of claim 1, wherein the load adjustment simulation operation further comprises a step of indicating a state of the second charging station as the service suspended state in a user query interface by the server when the power output from the first charging station to the electric vehicle during the charging operation is not adjusted to the specific value.

3. The method of claim 1, wherein the load adjustment simulation operation further comprises a step of communicating with the first charging station through the network by the server to instruct the first charging station to adjust the power parameter from the specific value back to the upper power limit value of the first charging station during the charging operation when the power output from the first charging station to the electric vehicle during the charging operation is adjusted to the specific value.

4. The method of claim 1, wherein the specific value id a lower power limit value of the first charging station.

5. The method of claim 1, further comprising:
sending a confirmation request to a specific mobile device corresponding to the electric vehicle via the network by the server;
receiving a confirmation signal in response to the confirmation request from the specific mobile device via the network; and
in response to the confirmation signal, executing the load adjustment simulation operation by the server.

6. A charging management system for electric vehicle charging stations for use in a charging field with a power limit, comprising:
a first charging station performing a charging operation for an electric vehicle using a power parameter, wherein the power parameter is an upper power limit value of the first charging station;
a second charging station; and
a server respectively connecting with the first charging station and the second charging station via a network, calculating a remaining power of the charging field according to the power limit of the charging field and the upper power limit value of the first charging station, determining whether the remaining power of the charging field is lower than the upper power limit value of the second charging station, and performing a load adjustment simulation operation when the remaining power of the charging field is lower than the upper power limit value of the second charging station, wherein in the load adjustment simulation operation, the server communicates with the first charging station through the network to instruct the first charging station to adjust the power parameter from the upper power limit value to a specific value during the charging operation, monitors the power output from the first charging station to the electric vehicle during the charging operation, determines whether the power output from the first charging station to the electric vehicle during the charging operation is adjusted to the specific value, and sets the second charging station to be in a service suspended state when the power output from the first charging station to the electric vehicle during the charging operation is not adjusted to the specific value.

7. The system of claim 6, wherein in the load adjustment simulation operation, the server further indicates a state of the second charging station as the service suspended state in a user query interface when the power output from the first charging station to the electric vehicle during the charging operation is not adjusted to the specific value.

8. The system of claim 6, wherein in the load adjustment simulation operation, the server further communicates with the first charging station through the network to instruct the first charging station to adjust the power parameter from the specific value back to the upper power limit value of the first charging station during the charging operation when the power output from the first charging station to the electric vehicle during the charging operation is adjusted to the specific value.

9. The system of claim 6, wherein the specific value id a lower power limit value of the first charging station.

10. The system of claim 6, wherein the server further sends a confirmation request to a specific mobile device corresponding to the electric vehicle via the network, receives a confirmation signal in response to the confirmation request from the specific mobile device via the network, and executes the load adjustment simulation operation in response to the confirmation signal.

11. A machine-readable storage medium comprising a computer program, which, when executed, causes a device to perform a charging management method for electric vehicle charging stations for use in a charging field with a power limit, wherein the charging field comprises a first charging station and a second charging station which are respectively connected with a server via a network, wherein the method comprises:
performing a charging operation for an electric vehicle using a power parameter by the first charging station, wherein the power parameter is an upper power limit value of the first charging station;
calculating a remaining power of the charging field according to the power limit of the charging field and the upper power limit value of the first charging station;
determining whether the remaining power of the charging field is lower than the upper power limit value of the second charging station; and
performing a load adjustment simulation operation by the server when the remaining power of the charging field is lower than the upper power limit value of the second charging station, wherein the load adjustment simulation operation comprises the steps of:
communicating with the first charging station through the network by the server to instruct the first charging station to adjust the power parameter from the upper power limit value to a specific value during the charging operation;
monitoring the power output from the first charging station to the electric vehicle during the charging operation;
determining whether the power output from the first charging station to the electric vehicle during the charging operation is adjusted to the specific value; and
setting the second charging station to be in a service suspended state by the server when the power output from the first charging station to the electric vehicle during the charging operation is not adjusted to the specific value.
